(19) United States
(12) Patent Application Publication
(10) Pub. No.: US 2026/0247078 A1
(43) Pub. Date: Aug. 20, 2026

(54) LOUDSPEAKER

(71) Applicant: MERRY ELECTRONICS (SUZHOU) CO., LTD., Jiangsu Province (CN)

(72) Inventors: Jiawei Zhu, Jiangsu Province (CN); Mingya Luo, Jiangsu Province (CN)

(73) Assignee: MERRY ELECTRONICS (SUZHOU) CO., LTD., Jiangsu Province (CN)

(21) Appl. No.: 19/448,942

(22) Filed: Jan. 14, 2026

(30) Foreign Application Priority Data
Feb. 18, 2025 (CN) 202520259483.0
Feb. 18, 2025 (CN) 202520260268.2

(51) Int. Cl. H04R 9/02; H04R 1/06; H04R 1/24; H04R 7/18; H04R 9/04; H04R 9/06

(52) U.S. Cl. CPC H04R 9/025; H04R 1/06; H04R 1/24; H04R 7/18; H04R 9/047; H04R 9/06; H04R 2207/021

(57) ABSTRACT

Provided is a loudspeaker including a spacing member, a magnetic assembly, and a moving member. The magnetic assembly includes a first magnetic member and a second magnetic member. The spacing member is arranged between the first magnetic member and the second magnetic member. The spacing member, the first magnetic member and the second magnetic member form an accommodating cavity. A first magnetic gap is formed between the first magnetic member and the second magnetic member form a first magnetic gap. The moving member includes a first diaphragm and a first voice coil arranged on the first diaphragm. The first voice coil and at least a part of the first diaphragm are located in the accommodating cavity, and at least a part of the first voice coil is located in the first magnetic gap.

### CROSS-REFERENCE TO RELATED APPLICATION

This application claims the benefits of Chinese Patent Application No. 202520260268.2, filed on February 18, 2025, entitled “Loudspeaker” and Chinese Patent Application No. 202520259483.0, filed on February 18, 2025, entitled “Loudspeaker”, which are incorporated herein by reference in its entirety.

### FIELD

The present disclosure relates to a loudspeaker.

### BACKGROUND

In a traditional loudspeaker, a vibration system and a magnetic circuit system are respectively located on upper and lower sides, thus reserving more space for movement of a voice coil. As a result, the loudspeaker occupies an excessively large volume. In addition, the magnetic circuit system is located inside the loudspeaker, which is also unfavorable for spatial arrangement of the loudspeaker and other parts. How to reduce an occupied space and optimize spatial arrangement of the loudspeaker has become a problem that needs to be solved.

### SUMMARY

Embodiments of the present disclosure provide a loudspeaker.

The loudspeaker of the embodiments of the present disclosure includes: a spacing member, a magnetic assembly, and a moving member. The magnetic assembly includes a first magnetic member and a second magnetic member. The spacing member is arranged between the first magnetic member and the second magnetic member. The spacing member, the first magnetic member and the second magnetic member form an accommodating cavity. A first magnetic gap is formed between the first magnetic member and the second magnetic member form a first magnetic gap. The moving member includes a first diaphragm and a first voice coil arranged on the first diaphragm. The first voice coil and at least a part of the first diaphragm are located in the accommodating cavity, and at least a part of the first voice coil is located in the first magnetic gap.

### BRIEF DESCRIPTION OF DRAWINGS

The above and other objectives, features and advantages of the present disclosure will become more apparent from the following description of the embodiments of the present disclosure with reference to the accompanying drawings, in which:

FIG. 1 is a schematic structural diagram of a loudspeaker viewing from one side provided by a first embodiment of the present disclosure;

FIG. 2 is a schematic structural diagram of the loudspeaker viewing from another side provided by the first embodiment of the present disclosure;

FIG. 3 is a schematic exploded diagram of the loudspeaker provided by the first embodiment of the present disclosure;

FIG. 4 is a cross-section schematic diagram of the loudspeaker provided by the first embodiment of the present disclosure;

FIG. 5 is a schematic structural diagram of a magnetic assembly provided by the first embodiment of the present disclosure;

FIG. 6 is a schematic exploded diagram of a first magnetic member, a second diaphragm and a second voice coil provided by a second embodiment of the present disclosure;

FIG. 7 is a partial cross-section schematic diagram of a loudspeaker provided by the second embodiment of the present disclosure;

FIG. 8 is a schematic exploded diagram of a first magnetic member, a second diaphragm and a second voice coil provided by a third embodiment of the present disclosure;

FIG. 9 is a partial cross-section schematic diagram provided by the third embodiment of the present disclosure;

FIG. 10 is a schematic structural diagram of a connecting member provided by a fourth embodiment of the present disclosure;

FIG. 11 is a schematic exploded diagram of the connecting member provided by the fourth embodiment of the present disclosure;

FIG. 12 is a schematic exploded diagram of the connecting member and a first ring body provided by the fourth embodiment of the present disclosure; and

FIG. 13 is a schematic exploded diagram of a loudspeaker provided by a fifth embodiment of the present disclosure.

### DETAILED DESCRIPTION OF THE EMBODIMENTS

The following describes the present disclosure based on embodiments, but the present disclosure is not limited to these embodiments. In the following detailed description of the present disclosure, some specific details are described in detail. Those skilled in the art may also fully understand the present disclosure without the descriptions of the details. In order to avoid confusing the substance of the present disclosure, well-known methods, processes, procedures, elements, and circuits are not described in detail.

In addition, those of ordinary skill in the art should understand that the drawings provided herein are for illustrative purposes and are not necessarily drawn to scale.

Unless the context clearly requires otherwise, similar words such as "including" and "comprising" throughout the application document should be interpreted as inclusive rather than exclusive or exhaustive; that is to say, it means "including but not limited to".

In the description of the present disclosure, it should be understood that the terms "first", "second", and the like are used for descriptive purposes only and cannot be construed as indicating or implying relative importance. In addition, in the description of the present disclosure, the term "a plurality of" means two or more, unless otherwise stated.

Unless otherwise specified and limited, the terms "mounted", "connected", "connection", "fixed", and the like should be understood broadly. For example, the "connection" may be a fixed connection, a detachable connection, or an integrated connection, may be a direct connection or an indirect connection by means of an intermediate medium, or may be an internal connection of two elements or an interaction between two elements. For those of ordinary skill in the art, specific meanings of the above terms in the present disclosure can be understood according to specific circumstances.

For ease of description, the spatially relative terms such as "in", "out", "under", "below", "lower", "above", "upper", etc., are used to describe a relationship between one element or feature and another element or feature shown in the figures herein. It will be understood that spatially related terms may be intended to include different orientations of a device in use or operation in addition to the orientation depicted in the figures. For example, if the device in the figures is flipped, it is described that elements "below" or "under" other elements or features are positioned to be "above" other elements or features. Therefore, exemplary terms "below" can include both orientations of "above" and "below". The device be otherwise oriented (rotated 90 degrees or at other orientations) and the spatially relative descriptors used herein may likewise be interpreted accordingly.

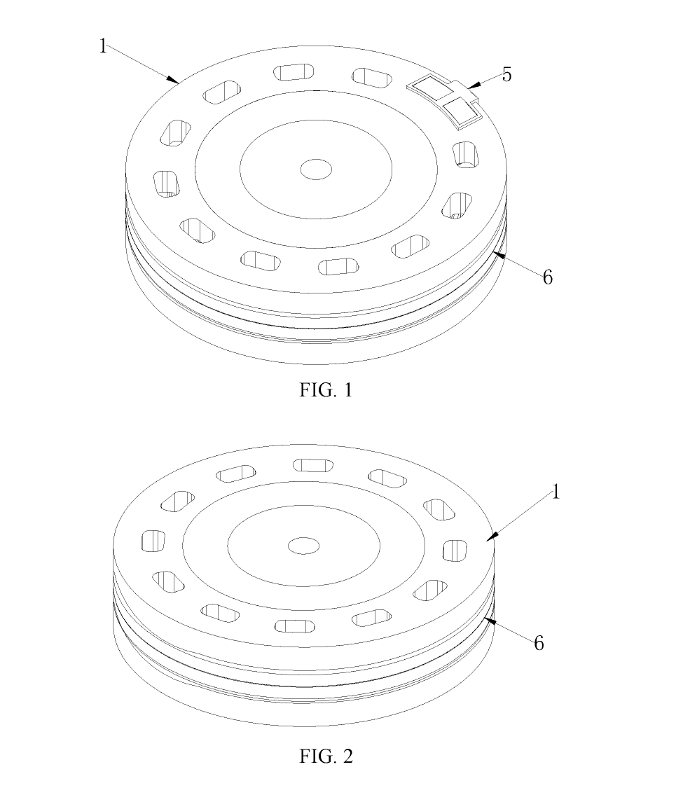

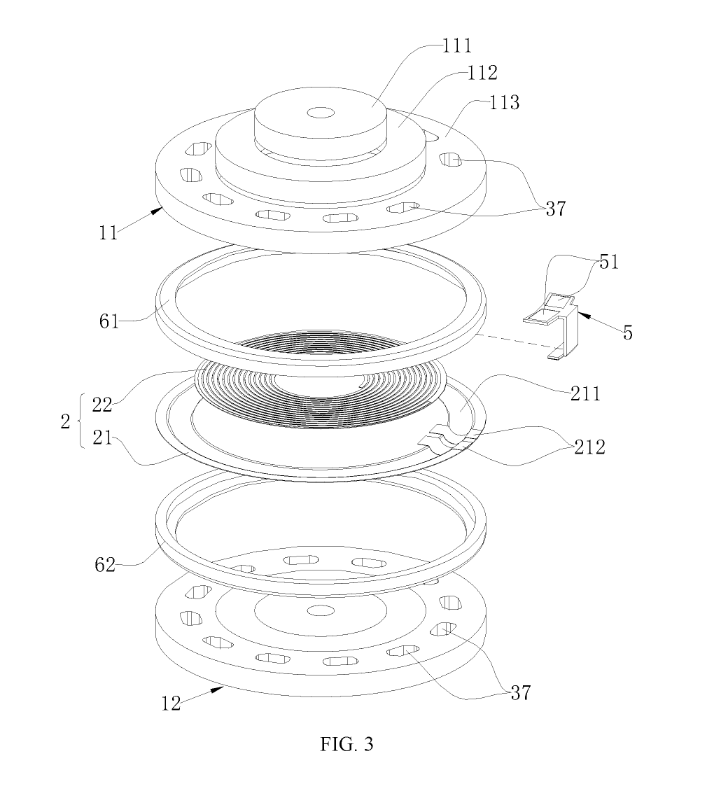

FIG. 1 and FIG. 2 are schematic structural diagrams of a loudspeaker provided by a first embodiment. FIG. 3 is a schematic exploded diagram of the loudspeaker provided by the first embodiment.

As shown in FIGS. 1-3, the loudspeaker in this embodiment includes a magnetic assembly 1, a moving member 2, and a spacing member 6. The magnetic assembly 1 includes a first magnetic member 11 and a second magnetic member 12 arranged opposite to and spaced apart from each other. Two sides of the spacing member 6 are fixedly connected to the first magnetic member 11 and the second magnetic member 12 respectively. A first magnetic gap 41 is formed between the first magnetic member 11 and the second magnetic member 12. The spacing member 6, the first magnetic member 11 and the second magnetic member 12 form an accommodating cavity 33.

In some embodiments, the first magnetic member 11 and the second magnetic member 12 each have a first side surface and a second side surface. The first side surface of the first magnetic member 11 is on a side close to the second magnetic member 12, and the first side surface of the second magnetic member 12 is on a side close to the first magnetic member 11. The second side surface of the first magnetic member 11 is on a side away from the second magnetic member 12, and the second side surface of the second magnetic member 12 is on a side away from the first magnetic member 11. The first magnetic gap 41 is formed between the first side surface of the first magnetic member 11 and the first side surface of the second magnetic member 12. A region defined by the two first side surfaces and a side wall, facing the first magnetic gap 41, of the spacing member 6 forms the accommodating cavity 33.

In some embodiments, the first side surfaces and the second side surfaces are parallel and planar. The two first side surfaces are arranged parallel to each other, so that each region of the first magnetic gap 41 remains consistent in a height direction. This improves stability of the moving member 2 in vibration.

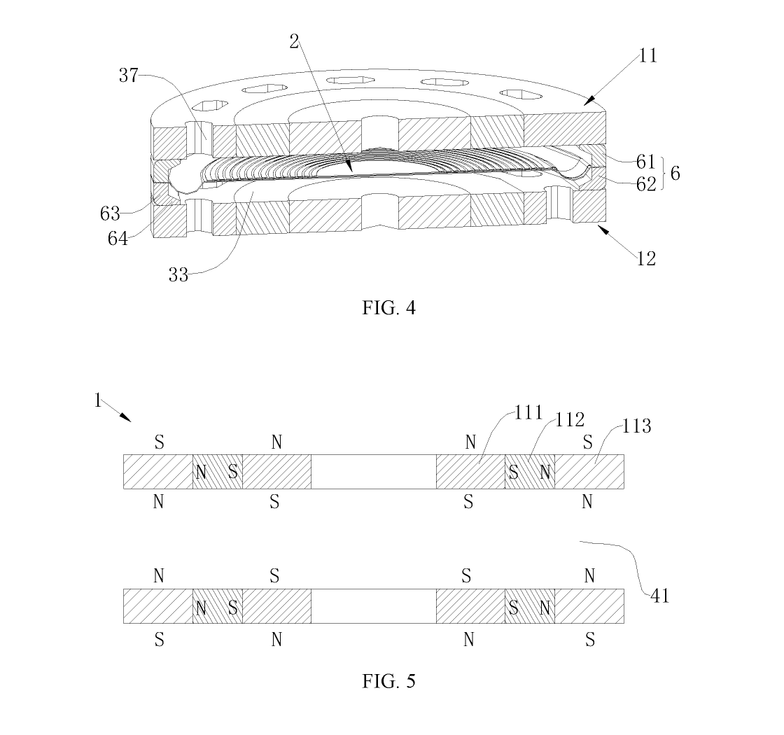

FIG. 4 is a cross-section schematic diagram of the loudspeaker provided by the first embodiment. FIG. 5 is a schematic structural diagram of a magnetic assembly 1 provided by the first embodiment.

Referring to FIGS. 4-5, the moving member 2 includes a first diaphragm 21 and a first voice coil 22 arranged on the first diaphragm 21. The first voice coil 22 and at least a part of the first diaphragm 21 are located in the accommodating cavity 33, and at least a part of the first voice coil 22 is located in the first magnetic gap 41. After a control circuit supplies power to the first voice coil 22, the first voice coil 22 within the first magnetic gap 41, under the action of an Ampere force, moves back and forth between the first magnetic member 11 and the second magnetic member 12, thereby driving the first diaphragm 21 to vibrate.

In the loudspeaker in this embodiment, the spacing member 6 is arranged between the first magnetic member 11 and the second magnetic member 12, thereby forming the accommodating cavity 33 for accommodating the moving member 2. Thus, in one aspect, directly utilizing the first magnetic member 11 and the second magnetic member 12 to form a part of the accommodating cavity 33 can effectively reduce a space occupied by the loudspeaker and lighten the loudspeaker's weight, making installation of the loudspeaker more convenient. In another aspect, a volume of a magnetic assembly 1 is increased, thereby enhancing an intensity of a magnetic field of the magnetic assembly 1. This enables a first voice coil 22, under the action of the Ampere force, to reduce distortion of the loudspeaker and increase the loudspeaker's response speed. In yet another aspect, the magnetic field generated by the magnetic assembly 1 outside the loudspeaker can facilitate electronic elements around the loudspeaker to share the magnetic assembly 1, thereby increasing a degree of integrating the surrounding electronic elements to the loudspeaker and further reducing a cost of a product.

For example, as shown in FIG. 3, the first voice coil 22 is a planar voice coil. The first voice coil 22 may be a double-sided etched coil. For example, a coil is formed by etching a flexible copper-clad laminate, and the etched flexible copper-clad laminate is then attached to the first diaphragm (21) using glue. Alternatively, the first voice coil (22) may be directly formed on the first diaphragm (21) by chemical etching and other methods.

In some embodiments, as shown in FIGS. 1-4, the spacing member 6 is annular; an edge of the first diaphragm 21 is fixedly connected to the spacing member 6, and two sides of the spacing member 6 are fixedly connected to the first magnetic member 11 and the second magnetic member 12 respectively.

In this embodiment, the first diaphragm 21 and the spacing member 6 may first be fixedly connected together; and then the first magnetic member 11 and the second magnetic member 12 cover the two sides of the spacing member 6 respectively, and they are secured to the two sides of the spacing member 6 using the glue. In this way, an assembly procedure of the loudspeaker is simplified.

In some embodiments, as shown in FIGS. 3-4, the spacing member 6 includes a first ring body 61 and a second ring body 62 stacked together, and an edge of the first diaphragm 21 is clamped between the first ring body 61 and the second ring body 62. The first magnetic member 11 is fixedly connected to the first ring body 61, and the second magnetic member 12 is fixedly connected to the second ring body 62.

In some embodiments, the first ring body 61 and the second ring body 62 are of mirror symmetry. The first ring body 61 is fixedly connected to the first magnetic member 11, and the second ring body 62 is fixedly connected to the second magnetic member 12. Then, the first ring body 61 and the second ring body 62 are bonded to two sides of the edge of the first diaphragm 21 using glue.

In some embodiments, as shown in FIG. 4, the first ring body 61 and the second ring body 62 each include a spacing ring 63 and a flange 64. One side of the spacing ring 63 is abutted against the first diaphragm 21, and the other side is abutted against the first magnetic member 11 or the second magnetic member 12. The flange 64 is connected to one side, away from the first diaphragm 21, of the spacing ring 63, and is folded toward a center of the spacing member 6. The flange 64 is abutted against the first magnetic member 11 or the second magnetic member 12, thereby increasing a contact area between the spacing member 6 and the magnetic assembly 1. When the spacing member 6 and the magnetic assembly 1 are connected by glue, the connecting strength between the spacing member 6 and the magnetic assembly 1 is increased.

In some embodiments, as shown in FIGS. 3-4, the first magnetic member 11 and the second magnetic member 12 each include a magnetic ring group, and each magnetic ring group includes a plurality of magnetic rings arranged in a nested manner. The magnetic ring is provided with air holes 37. The accommodating cavity 33 communicates with an outer side of the loudspeaker by means of the air holes 37. The spacing member 6 is connected to the outer magnetic ring of the magnetic ring group.

In some embodiments, the magnetic ring group includes a first magnetic ring 111, a second magnetic ring 112, and a third magnetic ring 113, and a plurality of air holes 37 are uniformly formed in the third magnetic ring 113. This provides a sufficiently large flow cross-section for sound waves generated by the moving member 2.

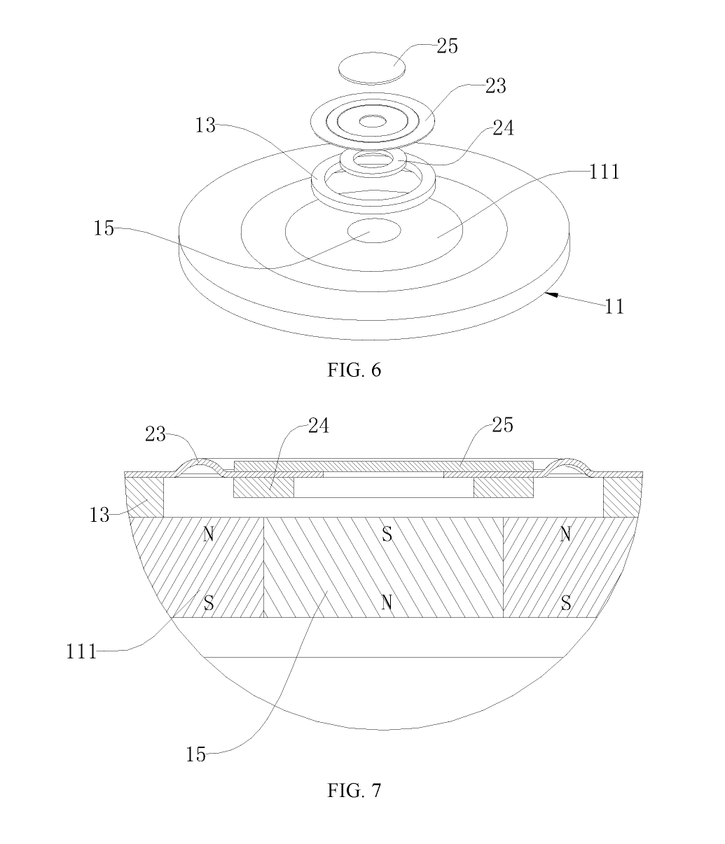

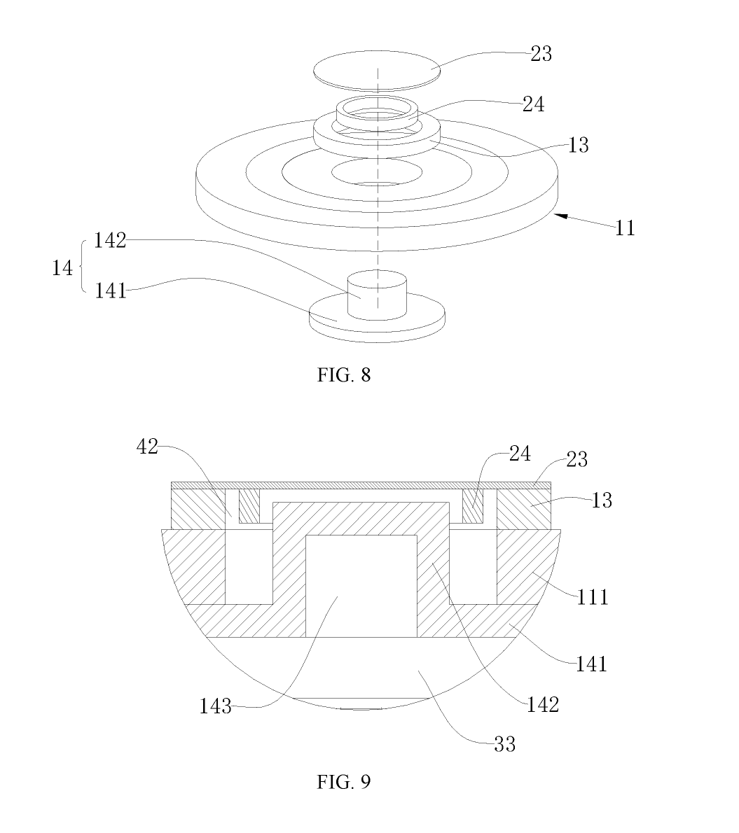

FIG. 6 is a schematic exploded diagram of a first magnetic member 11, a second diaphragm 23 and a second voice coil 24 provided by a second embodiment. FIG. 7 is a partial cross-section schematic diagram of a loudspeaker provided by the second embodiment. FIG. 8 is a schematic exploded diagram of a first magnetic member 11, a second diaphragm 23 and a second voice coil 24 provided by a third embodiment. FIG. 9 is a partial cross-section schematic diagram provided by the third embodiment.

In some embodiments, as shown in FIGS. 6-9, the moving member 2 further includes a second diaphragm 23 and a second voice coil 24. The second voice coil 24 is fixedly connected to the second diaphragm 23 and arranged on one side, away from the accommodating cavity 33, of the first magnetic member 11. At least a part of the second voice coil 24 is located within a magnetic field of the first magnetic member 11.

In this embodiment, the first diaphragm 21, the first voice coil 22, and the magnetic assembly 1 form a low‑frequency sound generation unit, while the second diaphragm 23, the second voice coil 24, and either the first magnetic member 11 or the second magnetic member 12 form a high‑frequency sound generation unit. In this way, the low‑frequency sound generation unit and the high‑frequency sound generation unit can supply sound waves in different frequency domains to the loudspeaker, thereby increasing the loudspeaker's loudness. In this embodiment, the loudspeaker may be applied to an earphone.

In some embodiments, there are two second diaphragm 23 and two second voice coils 24. One of the two second diaphragms 23, one of the two second voice coils 24, and the first magnetic member 11 form a first high‑frequency sound generation unit, and the other one of the two second diaphragms 23, the other one of the two second voice coils 24, and the second magnetic member 12 form a second high‑frequency sound generation unit. In this way, the loudness of high‑frequency sound waves is further increased.

In some embodiments, as shown in FIGS. 6-9, the magnetic assembly 1 further includes a magnetic permeance washer 13. The magnetic permeance washer 13 is attracted to the first magnetic member 11, the second diaphragm 23 is fixedly connected to one side, away from the first magnetic member 11, of the magnetic permeance washer 13, and the second voice coil 24 is fixedly connected to one side, close to the first magnetic member 11, of the second diaphragm 23 and located on an inner side of the magnetic permeance washer 13.

In this embodiment, the magnetic permeance washer 13 can improve a magnetic field generated by the first magnetic member 11, so that the second voice coil 24 is suitably arranged within the magnetic field of the first magnetic member 11. In addition, the magnetic permeance washer 13 also keeps the second voice coil 24 spaced apart from the first magnetic member 11, ensuring a sufficient moving space between the second voice coil 24 and the first magnetic member 11.

In some embodiments, as shown in FIGS. 6-7, the first magnetic member 11 includes a first magnetic ring 111, and the magnetic permeance washer 13 is attracted to first magnetic ring 111. At least a part of the second voice coil 24 is spaced apart from and arranged opposite to the first magnetic ring 111. The second voice coil 24 may be a planar voice coil, so as to reduce its dimension in an axial direction of the first magnetic ring 111 and prevent a collision between the second voice coil 24 and the first magnetic ring 111.

In some embodiments, as shown in FIGS. 6-7, the first magnetic member 11 further includes a central magnet 15, and the central magnet 15 is located in a center of the first magnetic ring 111 and is attracted to the first magnetic ring 111. The second voice coil 24 is arranged opposite to both the central magnet 15 and the first magnetic ring 111. In this embodiment, the central magnet 15 strengthens an overall magnetic force of the magnetic assembly 1, so that stronger Ampere force acts on the second voice coil 24.

In some embodiments, a circular cover 25 is provided on one side, away from the accommodating cavity 33, of the second diaphragm 23. The circular cover 25 optimizes vibration of the second diaphragm 23 and further improves a sound quality of the high‑frequency sound generation unit.

In some embodiments, as shown in FIGS. 8-9, the first magnetic member 11 includes a first magnetic ring 111, and the magnetic permeance washer 13 is attracted to the first magnetic ring 111. The magnetic assembly 1 further includes a central magnetic permeance member 14. The central magnetic permeance member 14 includes an inner plate 141 and a cylinder 142. The inner plate 141 is located on one side, close to the accommodating cavity 33, of the first magnetic ring 111 and attracted to the first magnetic ring 111. The cylinder 142 extends outward from a center of the first magnetic ring 111. A part of the cylinder 142 and an opposite side of the magnetic permeance washer 13 form a second magnetic gap 42. At least a part of the second voice coil 24 is located in the second magnetic gap 42.

The magnetic permeance washer 13 and the central magnetic permeance member 14 may be made from materials such as silicon steel, ferrite, or iron-boron alloys. After the magnetic permeance washer 13 and the central magnetic permeance member 14 are attracted to the first magnetic member 11, a part of the magnetic force of the magnetic assembly 1 can act on the second voice coil 24 by means of the second magnetic gap 42. In this way, the Ampere force acting on the second voice coil 24 is optimized.

The cylinder 142 extends from the inner plate 141 toward an outer side of the accommodating cavity 33 and passes through the first magnetic ring 111. An end portion of the cylinder 142 is arranged opposite to a part of the magnetic permeance washer 13. The cylinder 142 has a groove 143. An inner side surface of the groove 143 and an outer side surface of the cylinder 142 are both cylindrical surfaces, thereby further optimizing permeance of the magnetic field along the central magnetic permeance member 14.

In some embodiments, the inner side surface of the magnetic permeance washer 13 and the inner side surface of the first magnetic ring 111 are both cylindrical surfaces, and overlap in the axially. The second voice coil 24 is configured as a cylindrical voice coil. As a result, the first magnetic ring 111 can avoid the second voice coil 24, and make the magnetic field within the second magnetic gap 42 more uniform.

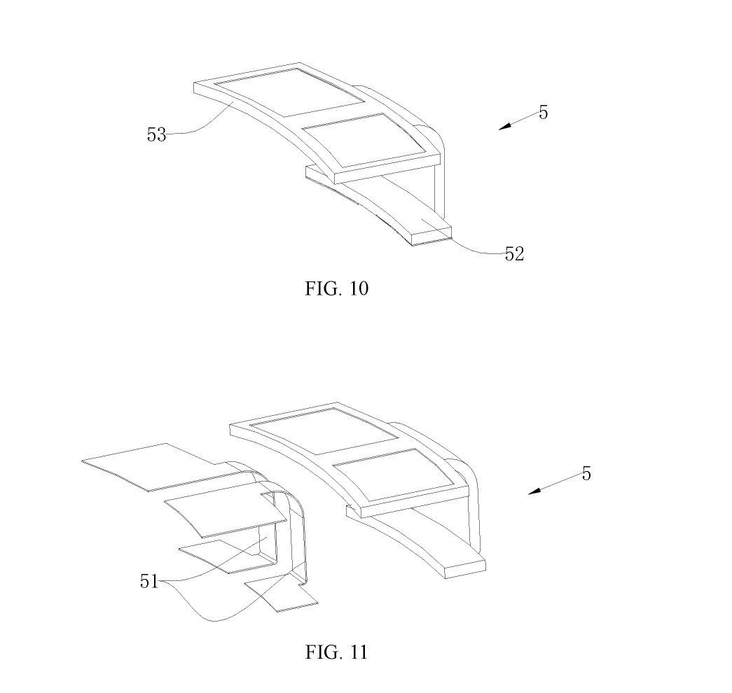

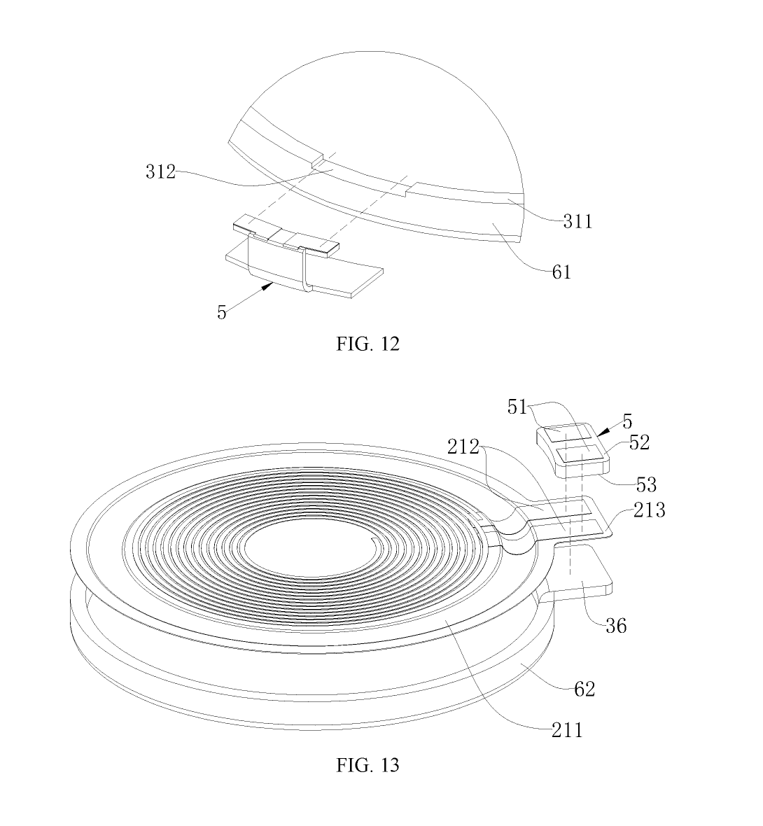

FIG. 10 is a schematic structural diagram of a connecting member 5 provided by a fourth embodiment. FIG. 11 is a schematic exploded diagram of the connecting member 5 provided by the fourth embodiment. FIG. 12 is a schematic exploded diagram of the connecting member 5 and a first ring body 61 provided by the fourth embodiment. FIG. 13 is a schematic exploded diagram of a loudspeaker provided by a fifth embodiment.

In some embodiments, as shown in FIGS. 10-13, the loudspeaker further includes a connecting member 5. The connecting member 5 is arranged on the first magnetic member 11 and/or the spacing member 6. The connecting member 5 has two electrical paths 51, and each electrical path has one end located outside of the accommodating cavity 33 and the other end electrically connected to the first voice coil 22. In this embodiment, the connecting member 5 is provided, so that the control circuit can supply power to the first voice coil 22 located inside the accommodating cavity 33, thereby controlling vibration of the moving member 2. In this way, a connecting mode of the loudspeaker is simplified.

In some embodiments, as shown in FIG. 3 and FIG. 13, the first diaphragm 21 includes a diaphragm film 211 and two conductive patterns 212 formed on the diaphragm film 211. The two conductive patterns 212 are arranged corresponding to the two electrical paths 51 respectively. Each conductive pattern 212 has one end connected to the first voice coil 22 and another end connected to an end of the corresponding electrical path 51.

For example, each conductive pattern 212 may be a silver nanowire coating layer on a side surface of the first diaphragm 21. In a case of the first voice coil 22 being attached to the first diaphragm 21, two connecting ends of the first voice coil 22 are electrically connected to end portions of the two silver nanowire coating layers respectively. The two conductive patterns 212 extend continuously from the first voice coil 22 to the edge of the first diaphragm 21, so as to facilitate their connection to the connecting member 5.

In some embodiments, as shown in FIG. 12, the first ring body 61 has a connecting surface 311, and the first ring body 61 is connected to the edge of the first diaphragm 21 by means of the connecting surface 311. An avoidance groove 312 is formed in the connecting surface 311. The connecting member 5 is a flexible printed circuit board. The flexible printed circuit board includes a first connecting end 52 and a second connecting end 53. Two ends of each electrical path 51 are arranged at the first connecting end 52 and the second connecting end 53 respectively. The first connecting end 52 is arranged on an outer surface of the first magnetic member 11, and the second connecting end 53 extends into the avoidance groove 312 along outer surfaces of the first ring body 61 and the first magnetic member 11. The end portions of the two electrical paths 51 are abutted against the two conductive patterns 212 respectively. In this embodiment, thanks to the flexibility of the flexible printed circuit board, the flexible printed circuit board is attached to the magnetic assembly 1 and the spacing member 6, thereby reducing a volume occupied by the loudspeaker.

In some embodiments, the first connecting end 52 is arranged at an edge of a second side surface of the first magnetic member 11. The second connecting end 53 extends from a side surface of the first ring body 61 into the avoidance groove 312. Each electrical path 51 includes a first contact and a second contact. The first contact is exposed on the first connecting end 52 and faces one side, away from the first diaphragm 21, of the first connecting end 52. The second contact is exposed on the second connecting end 53 and faces the first diaphragm 21. In a case of the first ring body 61 and the second ring body 62 clamping the edge of the first diaphragm 21, the second contact is abutted against the end portion of the conductive pattern 212, while the other end portion of the conductive pattern 212 extends toward the center of the first diaphragm 21 and is connected to the first voice coil 22. In this way, electrical connection between the connecting member 5 and the first voice coil 22 is achieved.

In some embodiments, as shown in FIG. 13, the spacing member 6 further includes a support lug 36, which is protruded from an outer surface of the second ring body 62. The diaphragm film 211 includes an extension region 213, which is arranged at an edge of the diaphragm film 211 and extends to the support lug 36. The end portions of the two conductive patterns 212 extend into the extension region 213. The connecting member 5 is a rigid printed circuit board, i.e., a PCB. Two opposing board surfaces of the rigid printed circuit board respectively form the first connecting end 52 and the second connecting end 53, and two ends of each electrical path 51 are arranged on the first connecting end 52 and the second connecting end 53 respectively. The rigid printed circuit board is provided with the extension region 213. End portions of the two electrical paths 51 at the first connecting end 52 are abutted against the two conductive patterns 212 respectively.

In some embodiments, the support lug 36 extends horizontally toward a lateral side of the second ring body 62. The support lug 36 is used for supporting the rigid printed circuit board and the extension region 213. After the rigid printed circuit board is installed in the extension region 213, the first contact is exactly oriented in a same direction as a second side surface of the first magnetic member 11.

Further, the spacing member 6 is made of a non-magnetic-permeance material. The non-magnetic-permeance material may be a metallic material such as aluminum or copper, or as a non‑metallic material such as plastics and rubber plastics. In this way, the spacing member 6 does not affect a magnetic force of the magnetic assembly 1.

In some embodiments, as shown in FIG. 5, the magnetic assembly 1 is configured in such a manner that a polarity of the first magnetic member 11 and a polarity of the second magnetic member 12 are of mirror symmetry. The south pole S of the third magnetic ring 113 is located on one side away from the first magnetic gap 41, and the north pole N of the third magnetic ring 113 is located on one side facing the first magnetic gap 41. The south pole S of the second magnetic ring 112 faces the first magnetic ring 111, and the north pole N of the second magnetic ring 112 faces the third magnetic ring 113. A polarity of the first magnetic ring 111 is opposite to that of the third magnetic ring 113.

Further, as shown in FIG. 8, the central magnet 15 is of a cylindrical structure, with its north pole N facing the accommodating cavity 33 and its south pole S located away from the accommodating cavity 33.

What stated above are merely exemplary embodiments of the present disclosure but are not used to limit the present disclosure, and various modifications and variations can be made in the present disclosure to those skilled in the art. Any modification, equivalent, improvement, etc. made within the spirit and principle of the present disclosure shall fall within the protection scope of the present disclosure.

What is claimed is:

1. A loudspeaker, comprising
a spacing member;
a magnetic assembly, comprising a first magnetic member and a second magnetic member, wherein the spacing member is arranged between the first magnetic member and the second magnetic member, the spacing member, the first magnetic member and the second magnetic member form an accommodating cavity, and a first magnetic gap is formed between the first magnetic member and the second magnetic member; and
a moving member, comprising a first diaphragm and a first voice coil arranged on the first diaphragm, wherein the first voice coil and at least a part of the first diaphragm are located in the accommodating cavity, and at least a part of the first voice coil is located in the first magnetic gap.

2. The loudspeaker according to claim 1, wherein the spacing member is annular, an edge of the first diaphragm is fixedly connected to the spacing member, and two sides of the spacing member are fixedly connected to the first magnetic member and the second magnetic member respectively.

3. The loudspeaker according to claim 2, wherein the spacing member comprises a first ring body and a second ring body, the edge of the first diaphragm is clamped between the first ring body and the second ring body, the first magnetic member is fixedly connected to the first ring body, and the second magnetic member is fixedly connected to the second ring body.

4. The loudspeaker according to claim 2, wherein the first magnetic member and the second magnetic member each comprise a magnetic ring group, the magnetic ring group comprises a plurality of magnetic rings arranged in a nested manner, an air hole is formed in a magnetic ring of the plurality of magnetic rings, the accommodating cavity communicates with an outer side of the loudspeaker through the air hole; and
the spacing member is connected to the outer magnetic ring of the magnetic ring group.

5. The loudspeaker according to claim 1, wherein the moving member further comprises:
a second diaphragm; and
a second voice coil, fixedly connected to the second diaphragm and arranged on one side, away from the accommodating cavity, of the magnetic assembly, wherein at least a part of the second voice coil is located within a magnetic field of the magnetic assembly.

6. The loudspeaker according to claim 5, further comprising a circular cover provided on a side, away from the accommodating cavity, of the second diaphragm.

7. The loudspeaker according to claim 5, wherein the second voice coil is a planar voice coil.

8. The loudspeaker according to claim 5, wherein the magnetic assembly further comprises: a magnetic permeance washer,
wherein the magnetic permeance washer is attracted to the first magnetic member, the second diaphragm is fixedly connected to one side, away from the first magnetic member, of the magnetic permeance washer, and the second voice coil is fixedly connected to one side, close to the first magnetic member, of the second diaphragm and located on an inner side of the magnetic permeance washer.

9. The loudspeaker according to claim 8, wherein the first magnetic member comprises a first magnetic ring, and the magnetic permeance washer is attracted to the first magnetic ring;
the magnetic assembly further comprises a central magnetic permeance member, the central magnetic permeance member comprises an inner plate and a cylinder, the inner plate is located in the accommodating cavity and is attracted to the first magnetic ring, the cylinder extends outward from a center of the first magnetic ring, a second magnetic gap is formed between a part of the cylinder and the magnetic permeance washer, and at least a part of the second voice coil is located in the second magnetic gap.

10. The loudspeaker according to claim 8, wherein the first magnetic member comprises a first magnetic ring, and the magnetic permeance washer is attracted to the first magnetic ring;
at least a part of the second voice coil is spaced apart from and arranged opposite to the first magnetic ring.

11. The loudspeaker according to claim 10, wherein the first magnetic member further comprises a central magnet, which is located in the center of the first magnetic ring and is attracted to the first magnetic ring; and
the second voice coil is arranged opposite to both the central magnet and the first magnetic ring.

12. The loudspeaker according to claim1, wherein at least one of the first magnetic member or the spacing member is provided with a connecting member, the connecting member comprises an electrical path, a first of the electrical path is located on an outer side of the accommodating cavity, and a second end of the electrical path is electrically connected to the first voice coil.

13. The loudspeaker according to claim 12, wherein the first diaphragm comprises a diaphragm film and a conductive pattern formed on the diaphragm film, and the conductive pattern is arranged corresponding to the electrical path; and
the conductive pattern has one end connected to the first voice coil and another end connected to the second end of the electrical path.

14. The loudspeaker according to claim 13, wherein the conductive pattern is a silver nanowire coating layer arranged on a side surface of the first diaphragm.

15. The loudspeaker according to claim 13, wherein the spacing member comprises a first ring body and a second ring body, the edge of the first diaphragm is clamped between the first ring body and the second ring body,；
the first ring body comprises a connecting surface, the first ring body is connected to an edge of the first diaphragm through the connecting surface, and the connecting surface comprises an avoidance groove.

16. The loudspeaker according to claim 15, wherein the connecting member comprises a first connecting end and a second connecting end, the first connecting end is arranged on an outer surface of the first magnetic member, the second connecting end extends into the avoidance groove along an outer surface of the first ring body, and the second end of the electrical path is abutted against the conductive pattern.

17. The loudspeaker according to claim 15, wherein the spacing member further comprises a support lug protruded from an outer surface of the second ring body, the diaphragm film comprises an extension region, the extension region is arranged at an edge of the diaphragm film and extends to the support lug, an end portion of the conductive pattern extends into the extension region, and the electrical path is arranged on the support lug and is abutted against the conductive pattern.

18. The loudspeaker according to claim 17, wherein the support lug extends horizontally toward a lateral side of the second ring body.

19. The loudspeaker according to claim 1, wherein the first voice coil is a planar voice coil.

20. The loudspeaker according to claim 1, wherein a polarity of the first magnetic member is mirror-symmetric to that of the second magnetic member.
